(19) United States
(12) Patent Application Publication
(10) Pub. No.: US 2008/0267020 A1
(43) Pub. Date: Oct. 30, 2008

(54) OPTICAL DISC APPARATUS AND FOCUS CONTROL METHOD

(75) Inventor: Kazuhisa IDE, Fukuoka (JP)

Correspondence Address: DICKINSON WRIGHT PLLC, 1901 L STREET NW, SUITE 800, WASHINGTON, DC, 20036, US

(73) Assignee: MATSUSHITA ELECTRIC INDUSTRIAL CO., LTD., OSAKA (JP)

(21) Appl. No.: 12/099,674

(22) Filed: Apr. 8, 2008

(30) Foreign Application Priority Data
Apr. 9, 2007 (JP) 2007-101536

(51) Int. Cl. G11B 7/00

(52) U.S. Cl. 369/44.14

(57) ABSTRACT

An optical disk apparatus that performs focus control and tracking control, the focus control focusing an objective lens on an optical disk, and the tracking control making the objective lens track a partial area on the optical disk. The optical disk apparatus has a light-blocking element and a light detector. The light-blocking element is disposed on a first light path on which light reflected by the optical disk travels, and blocks a part of the reflected light. The light detector detects, for the focus control, the reflected light which passes the light-blocking element. The light-blocking element has a predetermined area for blocking the reflected light, the predetermined area extending along a direction optically corresponding to the tracking direction in which the objective lens tracks, for the tracking control, the partial area on the optical disk.

### FIELD OF THE INVENTION

The present invention relates to an optical disk apparatus performing at least one process of recording data in an optical disc and reproducing the recorded data from the optical disc, and a focus control method using the optical disk apparatus.

### BACKGROUND OF THE RELATED ART

An optical disk apparatus performs recording and reproducing using a laser beam, which is emitted from a light source and is focused by an objective lens.

Additionally, while a spindle motor rotates an optical disk, the objective lens is operated in a manner that a focused light spot is adjacent to a guide groove or a signal pit of the optical disk. However, de-centering of either the spindle motor or the optical disk causes a signal pit or a guide groove to move in the radial direction of the optical disk (referred to as “tracking direction TD” hereinafter). In order to reduce the influence of the de-centering, the optical disk apparatus moves the objective lens in tracking direction TD in a manner that the focused light spot tracks the movement of the guide groove or the signal pit. In other words, the objective lens tracks a partial area of the optical disk in tracking direction TD. This control is called “tracking control.” The motion of the objective lens in the X-direction is referred to as “lens shift.”

The optical disk apparatus moves the objective lens further in the direction toward the surface of the optical disk (referred to as “focus direction FD” hereinafter) so as to keep a distance between the surface of the optical disk and the objective lens constant. Consequently, the laser beam is focused at the guide groove or the signal pit. This control is called “focus control.”

The “astigmatism method” is known as one example of a focus control method. Specifically, an astigmatic characteristic is added to light reflected from the optical disk. A detector, which detects the reflected light, generates a focus control signal according to distance, in focus direction FD, between the objective lens and the surface of the optical disk. The optical disk apparatus performs feedback control with the generated focus control signal, and controls the position of the objective lens.

In this astigmatism method, a cylindrical lens adds the astigmatic characteristic to the reflected light. The reflected light is received by plural detectors. Each detector converts the received light into electric signal. The laser beam is deformed according to distance between the surface of the optical disk and the objective lens. The optical disk apparatus calculates the distance with the electric signal, and moves the objective lens according to the calculated distance. The plural detectors (four-quadrant detector) are composed of four light receiving areas into which is divided by two directions as shown for example in FIG. 12A. One is a direction optically corresponding to tracking direction TD (in other words, perpendicular to focus direction FD, referred to as “X-direction XD” hereinafter). The other is a direction perpendicular both to tracking direction TD and to focus direction FD (referred to as “Y-direction YD” hereinafter). The focus control signal is calculated based on FE=(Ia+Id)+(Ic+Ib) if each current value from receiving areas is referred to as Ia, Ib, Ic, Id.

The center of the four-quadrant detector is aligned with the light axis of the light reflected from the optical disk. The diameter of the laser spot is properly adjusted to recording and reproducing processes so that the current values Ia, Ib, Ic, Id from receiving areas satisfy the follows: Ia=Ib=Ic=Id, that is, focus control signal FE=0.

Regarding the astigmatism method, it is desirable that the center of the four-quadrant detector is aligned with the light axis of light reflected from the optical disk. Actually, in some cases the four-quadrant detector is misplaced when the four-quadrant detector is installed in the optical system. As a result, the center of the four-quadrant detector is misaligned with the light axis of light reflected from the optical disk.

Under the situation where the misaligned direction is Y direction YD, if an optical pick-up moves in tracking direction TD, errors of the focus control signal occur by the signal pit or the guide groove. Consequently, when the objective lens moves in focus direction FD, there is a malfunction in focus control.

In order to solve the above-mentioned problem, for example, Japanese Patent Laid-Open No. 1996-309687 discloses examples of optical disk apparatuses. The optical disk apparatuses have an optical element which makes the central intensity of reflected light value less than the peripheral intensity so as to reduce errors of the focus control signal.

However, the following problem is unsolved even if such optical disk apparatuses are used.

Referring to FIGS. 12A to 12F, the hatching portion shows the reflected light. That is, FIGS. 12A to 12F shows the positional relationship between four-quadrant detector 2001 and the light.

Referring to FIGS. 12B, 12D and 12F, the center of the four-quadrant detector is misaligned with the light axis of the reflected light. Even if the tracking control is performed in each of FIGS. 12A and 12B, focus control signals, which are calculated with FE=(Ia−Id)+(Ic−Ib), in FIGS. 12A and 12B, are the same as each other (each is zero). However, if the tracking control is performed in FIGS. 12C, 12D, 12E and 12F, focus control signals in FIGS. 12C and 12E become zero. However, in FIGS. 12A and 12B, because the light axis of the reflected light misaligns with the center of four-quadrant detector 2001 along not only the Y-direction but also the X-direction, the focus control signal does not become zero. As a result, focus control signals in FIGS. 12C and 12D are different from each other, and focus control signals in FIGS. 12E and 12F are different from each other. Finally, the focus control produces errors.

Thus, regarding calculation of the focus control signal using the astigmatism method, there is an unsolved problem as follows: if the light axis misaligns with the center of four-quadrant detector 2001 in Y-direction YD, and the objective lens moves in tracking direction TD by the lens shift of the tracking control, errors are observed in the focus control signal.

Additionally, if the diameter of the objective lens, which is opposite to the optical disk, is less than about 1 mm, the distance of the lens shift becomes relatively longer. This distance makes the moving distance longer. The moving distance is the distance for which the light moves in X-direction XD on four-quadrant detector. Consequently, errors in the focus control signal become greater. Under this situation, it is difficult to downsize the optical disk apparatus by downsizing the objective lens and optical system.

### SUMMARY

To address the above-described problems, an object is to provide an optical disk apparatus and a focus control method, which are capable of reducing errors in the focus control signal occurring according to the lens shift of the optical lens, and improving accuracy in reading data from the optical disk.

One or more objects may be achieved by an optical disk apparatus that performs focus control and tracking control, the focus control focusing an objective lens on an optical disk, and the tracking control making the objective lens track a partial area on the optical disk. The optical disk apparatus has a light-blocking element and a light detector. The light-blocking element is disposed on first light path on which light reflected by the optical disk travels, and blocks a part of the reflected light. The light detector detects, for the focus control, the reflected light blocked by the light-blocking element. The light-blocking element has a predetermined area for blocking the reflected light, the predetermined area extending along direction optically corresponding to the tracking direction in which the objective lens tracks, for the tracking control, the partial area on the optical disk.

Accordingly, the light detector receives the light blocked with the predetermined area extending along the tracking direction. Even if the light detector is misplaced along direction perpendicular both to the tracking direction and to light axis of light reflected from the optical disk, it is possible reduce influence of the misplacement on detection of the light detector. In a result, because of reducing errors in the focus control while performing tracking control, it is possible to improve accuracy in reading data from the optical disk.

One or more objects may be also achieved by a focus control method that performs focus control, the focus control focusing an objective lens on an optical disk, and the objective lens tracking a partial area on the optical disk by tracking control. The focus control method has blocking a part of light reflected by the optical disk, and detecting the blocked light for the focus control. The reflected light is blocked with a predetermined area, the predetermined area extending along direction optically corresponding to the tracking direction in which the objective lens tracks, for the tracking control, the partial area on the optical disk.

Accordingly, a light detector receives the light blocked with the predetermined area extending along the tracking direction. Even if the light detector is misplaced along direction perpendicular both to the tracking direction and to light axis of light reflected from the optical disk, it is possible reduce influence of the misplacement on detection of the light detector. In a result, because of reducing errors in the focus control while performing tracking control, it is possible to improve accuracy of focus control method.

### BRIEF DESCRIPTION OF THE DRAWINGS

The accompanying drawings, which are incorporated in and constitute a part of the specification, illustrate presently preferred non-limiting examples of exemplary embodiments of the invention, and, together with the general description given above and the detailed description of the preferred embodiments given below, serve to explain the principles and concepts of the invention, in which like reference characters designate like or corresponding parts throughout the several drawings. Preferred embodiments of the present invention will now be further described in the following paragraphs of the specification and may be better understood when read in conjunction with the attached drawings, in which:

FIG. 1 is a perspective view illustrating an optical disk apparatus according to first, second and third embodiment.

FIG. 2 is a block diagram illustrating optical system according to the first embodiment.

FIG. 3 is a perspective view illustrating a light-blocking element according to the first embodiment.

FIG. 4 is a block diagram illustrating focus control system according to the first embodiment.

FIG. 5A illustrates positional relationship between the four-quadrant detector and the light beam with lens shift zero according to the first embodiment.

FIG. 5B illustrates positional relationship between the four-quadrant detector and the light beam with lens shift zero according to the first embodiment.

FIG. 5C illustrates positional relationship between the four-quadrant detector and the light beam with lens shift zero according to the first embodiment.

FIG. 5D illustrates positional relationship between the four-quadrant detector and the light beam with lens shift in plus X direction according to the first embodiment.

FIG. 5E illustrates positional relationship between the four-quadrant detector and the light beam with lens shift in plus X direction according to the first embodiment.

FIG. 5F illustrates positional relationship between the four-quadrant detector and the light beam with lens shift in plus X direction according to the first embodiment.

FIG. 5G illustrates positional relationship between the four-quadrant detector and the light beam with lens shift in minus X direction according to the first embodiment.

FIG. 5H illustrates positional relationship between the four-quadrant detector and the light beam with lens shift in minus X direction according to the first embodiment.

FIG. 5I illustrates positional relationship between the four-quadrant detector and the light beam with lens shift in minus X direction according to the first embodiment.

FIG. 6 is a graph indicating relationship between focus control signal and misalignment in Y-direction of four-quadrant detector when focusing the laser beam on an optical disk, according to the first embodiment.

FIG. 7 is a flowchart illustrating focus control according to the first embodiment.

FIG. 8 is a block diagram illustrating optical system according to the second embodiment.

FIG. 9 is a perspective view illustrating a beam splitter according to the second embodiment.

FIG. 10 a block diagram illustrating optical system according to the third embodiment.

FIG. 11 is a perspective view illustrating a reflection mirror according to the third embodiment.

FIG. 12A illustrates positional relationship between a four-quadrant detector and light beam with lens shift zero according to the related art.

FIG. 12B illustrates positional relationship between a four-quadrant detector and light beam with lens shift zero according to the related art.

FIG. 12C illustrates positional relationship between a four-quadrant detector and light beam with lens shift in plus X-direction according to the related art.

FIG. 12D illustrates positional relationship between a four-quadrant detector and light beam with lens shift in plus X-direction according to the related art.

FIG. 12E illustrates positional relationship between a four-quadrant detector and light beam with lens shift in minus X-direction according to the related art.

FIG. 12F illustrates positional relationship between a four-quadrant detector and light beam with lens shift in minus X-direction according to the related art.

### DETAILED DESCRIPTION

### First Embodiment

Reference will now be made in detail to the presently non-limiting, exemplary and preferred embodiments of the invention as illustrated in the accompanying drawings. The nature, concepts, objectives and advantages of the present invention will become more apparent to those skilled in the art after considering the following detailed description in connection with the accompanying drawings. The following description is provided in order to explain preferred embodiments of the present invention, with the particular features and details shown therein being by way of non-limiting illustrative examples of various embodiments of the present invention. The particular features and details are presented with the goal of providing what is believed to be the most useful and readily understood description of the principles and conceptual versions of the present invention. In this regard, no attempt is made to show structural details of the invention in more detail than is necessary for the fundamental understanding of the present invention. The detailed description considered with the appended drawings are intended to make apparent to those skilled in the art how the several forms of the present invention may be embodied in practice.

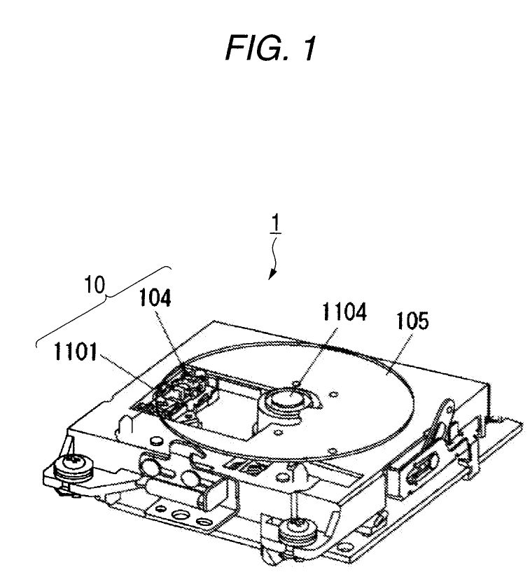

The first embodiment will now be described with reference to FIGS. 1 through 7.

Referring to FIG. 1, optical disk apparatus 1 has optical system 10 and spindle motor 1104. Optical system 10 includes optical pick-up 1101 and object lens 104 provided in optical pick-up 101. If optical disk 105 is mounted on spindle motor 1104, a light beam emitted from object lens 104 is focused on rotating optical disk 105, and data is retrieved from optical disk 105. Signal pits indicating data are arranged on tracks along the circumferential direction. Optical disk apparatus 1 has further a tracking control system (not shown in the drawings), which performs tracking control using objective lens 104. Specifically, objective lens 104 travels, according to de-centering of optical disk 105, back and forth in the tracking direction so that the focused spot tracks a signal pit or guide groove (not shown in the drawings) on optical disk 105. The motion of the objective lens in the tracking direction is referred to as “lens shift” hereinafter. Optical disk apparatus 1 is small-sized and records or reproduces data-from optical disk 105 with a diameter 32 mm, for example.

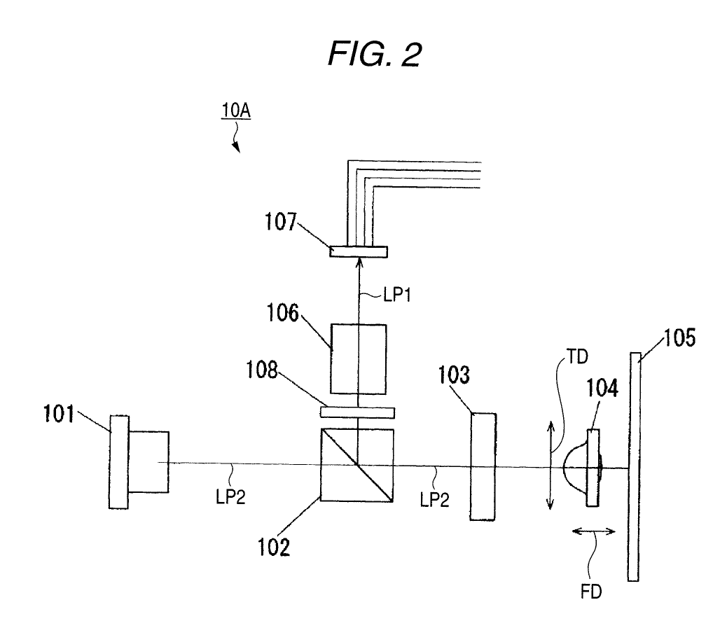

Referring to FIG. 2, optical system 10A has further laser diode 101, beam splitter 102, collimator lens 103, cylindrical lens 106, four-quadrant detector 107 and light-blocking element 108. Laser diode 101 emits a light beam (e.g., blue light flux) as a light source. “Light beam” is simply referred to as “light” hereinafter. The light emitted from laser diode 101 penetrates, through second light path LP2, beam splitter 102 and collimator lens 103. Objective lens 104, the numeric aperture of which is for example 0.73 or thereabouts, focuses the light on optical disk 105. Optical disk 105 has a transparent cover layer on its data surface; the cover layer has a thickness of for example 0.11 mm or thereabouts. The light penetrating the cover layer forms a focus spot on the data surface. If optical disk 105 rotates, the data surface periodically waggles in focus direction FD. The light is required to be focused on such a data surface during a recording and reproducing process. Optical disk apparatus 1 has a focus control system (hereinafter described), which performs focus control using objective lens 104. Specifically, the focus control system moves objective lens 104, according to displacement along focus direction FD of optical disk 105, so as to focus the light on optical disk 105.

Also, optical disk apparatus 1 has a tracking control system (not shown in the drawings). Specifically, the tracking control system periodically moves objective lens 104 in the radial direction of optical disk 105 (referred to as “tracking direction TD”), according to rotation of optical disk 105.

Objective lens 104 has a surface, which is opposite to optical disk 105, in the vicinity of about 1 mm in diameter. Since optical system 10A is downsized with this size, optical pick-up 1101 can be downsized enough to mount a small-sized optical disk apparatus as shown in this embodiment. A conventional objective lens 3 mm in diameter is used for a recording medium such as a CD (Compact Disk) and a DVD (Digital Versatile Disk) 120 mm in diameter. The proportion of lens shift to the diameter of objective lens 104 is about three times wider than the conventional objective lens. Specifically, the proportion increases by 7 to 20% compared with the conventional objective lens.

Beam splitter 102 reflects the light reflected from optical disk 105 toward first light path LP1. The reflected light travels along first light path LP1 which is different from second light path LP2, and penetrates light-blocking element 108. Light-blocking element 108 blocks a part of the light. After penetrating light-blocking element 108, the light reaches cylindrical lens 106 through first light path LP1. Cylindrical lens 106 adds an astigmatic characteristic to the light.

Four-quadrant detector 107 has four light receiving areas into which is divided by two directions as discussed previously. One is a direction optically corresponding to tracking direction TD1 (in other word, perpendicular to focus direction FD, referred to as “X-direction XD” hereinafter). The other is a direction perpendicular both to tracking direction TD and to focus direction FD (referred to as “Y-direction YD” hereinafter). The light axis is aligned with the center of four-quadrant detector 107.

Light-blocking element 108 blocks a specific area of the reflected light emitted by beam splitter 102. The specific area has a height extending from a boundary to predetermined length. The boundary divides four-quadrant detector 107, along X-direction XD, two pairs of light receiving areas. If cylindrical lens 106 adds the astigmatic characteristic to the light, the shape of the light on four-quadrant detector 107 varies according to distance FD from objective lens 104 to optical disk 105 in focus direction FD. Each light receiving area of four-quadrant detector 107 converts the shape of the light into an electric signal, and the detector outputs the electric signal.

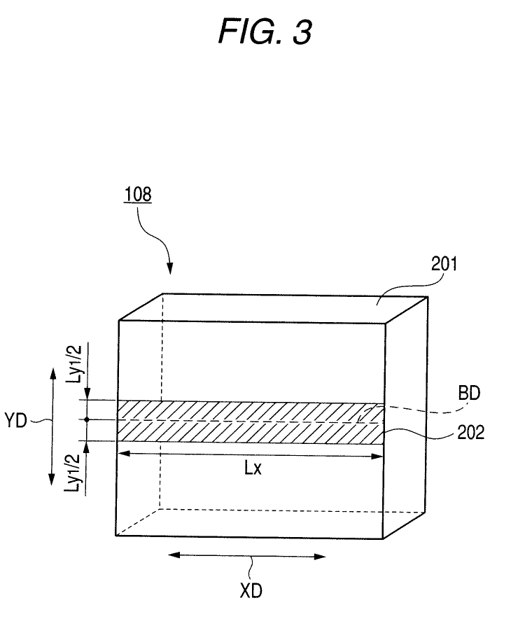

Referring to FIG. 3, light-blocking element 108 has transparent plate 201 and further has light-blocking film 202 (hatching portion) on transparent plate 201. Light-blocking film 202 is rectangular in shape, and has length Lx along X-direction XD and length Ly1 along Y-direction YD. Length Ly1 extends from boundary BD to Ly1/2h. Boundary BD divides, along X-direction XD, four light receiving areas, and blocks a part of the light by light-blocking film 202. That is, boundary BD is parallel to X-direction XD, and optically corresponding to tracking direction TD. Also, the shape of light-blocking film 202 is not limited to rectangular. As long as an area of light-blocking film 202 is shaped along boundary BD, any shape may be applied to achieve the effects of this invention.

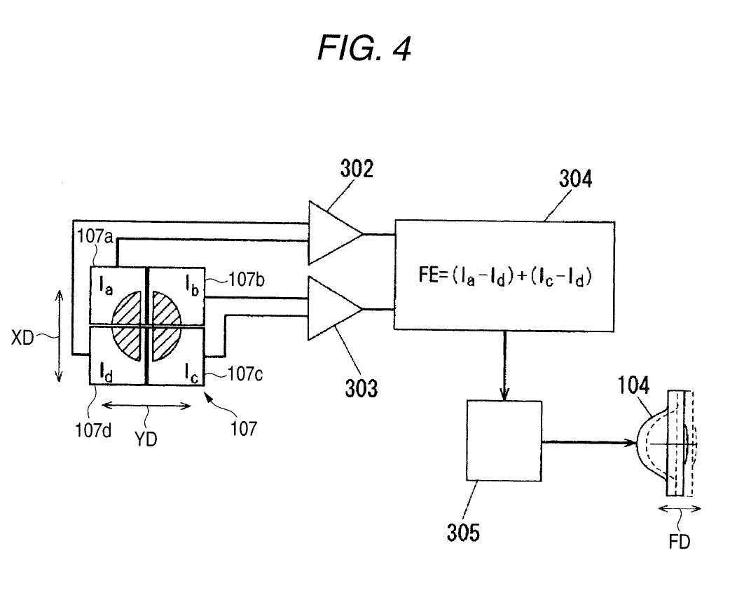

Referring to FIG. 4, four-quadrant detector 107 has four light receiving areas 107a, 107b, 107c, 107d divided by both X-direction XD and Y-direction YD. Each of the light receiving areas 107a, 107b, 107c, 107d outputs current values Ia, Ib, Ic, Id. After light-blocking element 108 blocks a part of the light by light-blocking film 202, the light reaches four-quadrant detector 107 through first light path LP1 as shown in FIG. 3.

Referring to FIG. 4, the optical disk apparatus has further the focus control system. The focus control system includes first amplifier 302, second amplifier 303, signal calculator 304 and drive signal generator 305. Each current value output from four light receiving areas of four-quadrant detector 107a, 107b, 107c, 107d is referred to as Ia, Ib, Ic, Id in clockwise order on the light axis. Light receiving areas 107a, 107d output current values Ia, Id towards first amplifier 302. Light receiving areas 107b, 107c output current values Ib, Ic towards second amplifier 303. First amplifier 302 subtracts the current value Id from the current value Ia, and outputs calculated result towards signal calculator 304. Second amplifier 303 subtracts the current value Ib from the current value Ic, and outputs calculated result towards signal calculator 304. Signal calculator 304 accumulates these calculated results. Thus, first amplifier 302, second amplifier 303 and signal calculator 304 calculate focus control signal based on the following equation: FE=(Ia+Id)+(Ic+Ib).

The shape of the light on four-quadrant detector 107 varies according to distance from objective lens 104 to optical disk 105 in focus direction FD. Current values Ia, Ib, Ic, Id vary according to variation of the light shape. Furthermore, focus control signals vary according to variation of the current values. However, the focus control system controls a position of objective lens 104 in focus direction FD in a manner that the focused spot of objective lens 104 is properly adjusted to recording and reproducing processes when focus control signal FE is equal to zero. Specifically, drive signal generator 305 generates a focus control signal so that FE is equal to zero. The focus control system moves objective lens 104 in focus direction FD using feedback control in a manner that the motion of objective lens 104 maintains focused status. Optical disk apparatus 1 records and reproduces data of optical disk 105 by the feedback control. Also, the tracking control system moves objective lens 104 so that the focused spot tracks a guide groove or the signal pit.

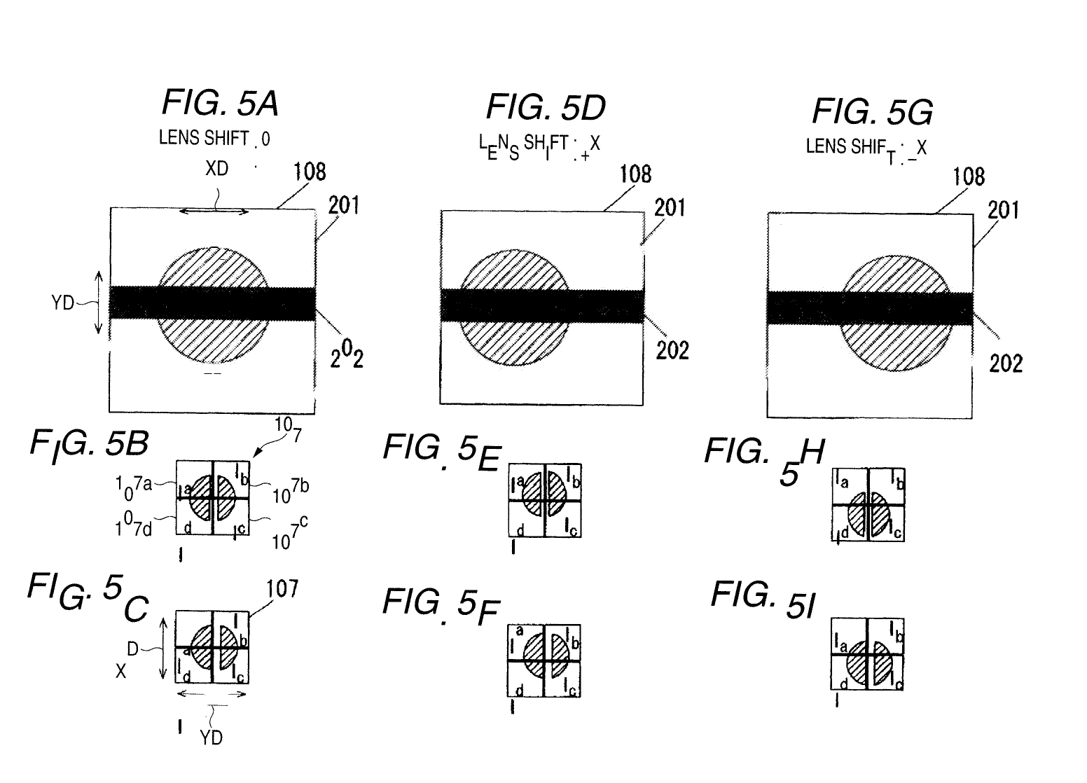

Referring to FIGS. 5A to 5I, the hatching portion shows the reflected light. That is, FIGS. 5A to 5I show a positional relationship between four-quadrant detector 2001 and the light corresponding to a positional relationship between light-blocking element 108 and the light.

Reflected light on light-blocking element 108 has a diameter of about 0.5 mm. Light-blocking film 202 on light-blocking element 108 has a height (Ly1 in FIG. 3) of 0.2 mm. The height extends from boundary BD to 0.1 mm. Boundary BD divides, along X-direction XD, four light receiving areas of four-quadrant detector 107. The light on four-quadrant detector 107 has a diameter of about 0.08 mm. Both reflected light on light-blocking element 108 and the light on four-quadrant detector 107 moves in X-direction XD according to lens shift of objective lens 104 by the tracking control.

When light reaches four-quadrant detector 107, light-blocking film 202 blocks an area extending from boundary BD, which divides one pair of light receiving areas 107a, 107d and the other pair of light receiving areas 107b, 107c, along X-direction XD, to length Ly1/2. Focus control signal FE in FIG. 5B is originally the same as that in FIG. 5C, however, it becomes the same as that in FIG. 5F. Moreover focus control signal FE becomes the same as that in FIG. 5I. Thus, even if the center of the four-quadrant detector 107 is misaligned with the light axis of the light reflected from optical disk 105, it is possible to reduce errors in focus control signal FE, and to curb influence of the misalignment in Y-direction YD.

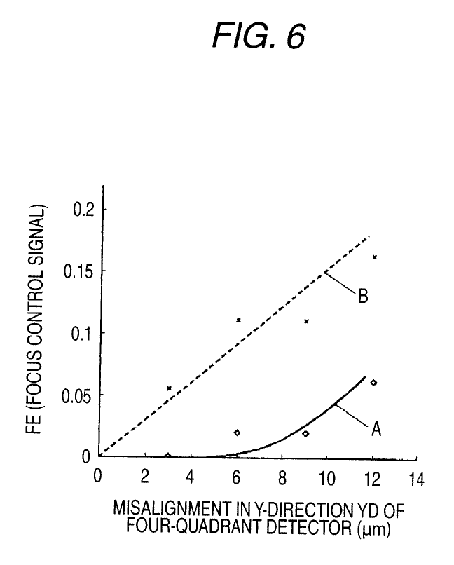

FIG. 6 shows a relationship between focus control signal FE and misalignment in Y-direction YD of the four-quadrant detector. While the light is moved in X-direction XD by the lens shift, each of focus control signals FE is plotted on the graph. Solid line A indicates the characteristics of optical disk apparatus 1 according to the first embodiment. Chain line B indicates the characteristics of a conventional optical disk apparatus. Also, lens shift is set at 49% compared with diameter of the light, and the focus control signal is calculated by FE=(Ia+Id)+(Ic+Ib).

Referring to FIG. 6, focus control signal FE of solid line A indicates values less than that of chain line B. That is, even if the center of four-quadrant detector 107 is misaligned with the light axis of light reflected from optical disk 105 in Y-direction YD, it is possible to reduce error in focus control signal FE compared with the conventional optical disk apparatus. Thus, optical disk apparatus 1 of the first embodiment has a wide tolerance with respect to the misalignment.

Moreover, since light-blocking element 108 is disposed between four-quadrant detector 107 and collimator lens 103 in the light path, even if light-blocking element 108 is misaligned, the misalignment distance on four-quadrant detector 107 does not become long as well as that of light-blocking element 108. Accordingly, it is possible to curb influence of the misalignment in Y direction YD by light-blocking element 108, and error in focus control signal FE can be reduced.

Furthermore, since light-blocking element 108 is disposed on first light path LP1 different from second light path LP2, distribution of light intensity does not become disturbed. Accordingly, it is possible to curb influence on a recording and reproducing process of optical disk apparatus 1.

Thus, optical disk apparatus 1 calculates focus control signal FE while suppressing influence of misalignment of four-quadrant detector 107. Optical disk apparatus 1 performs the focus control using the calculated focus control signal FE so that focus control signal FE is equal to zero by feedback control of objective lens 104. Therefore, it is possible to reduce errors in the focus control process compared with a conventional optical disk apparatus.

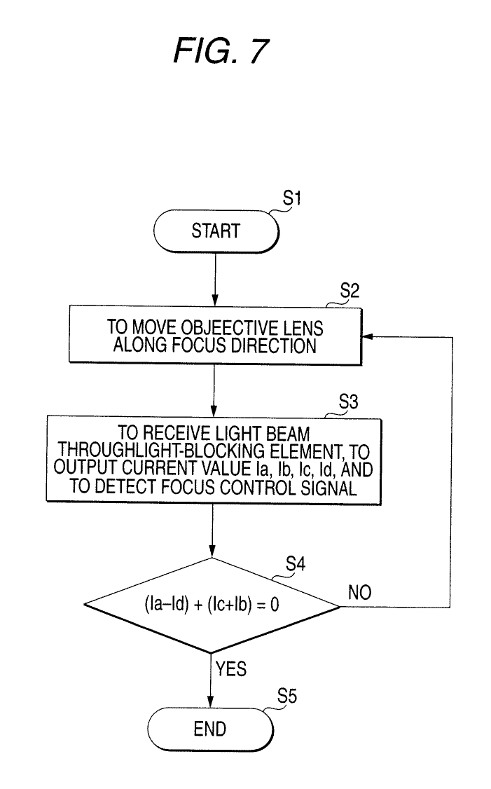

Referring to FIG. 7, the focus control system runs the focus control in response to activation of optical disk apparatus 1 (S1), and moves objective lens 104 in focus direction FD (S2). The reflected light reflected by optical disk 105 travels toward four-quadrant detector 107 through light-blocking element 108 and cylindrical lens 106. Four-quadrant detector 107 receives the light to which is added the astigmatic characteristic by cylindrical lens 106. Each light receiving area 107a, 107b, 107c, 107d outputs a respective current value Ia, Ib, Ic, Id according to the light intensity. Focus control signal FE is calculated by FE=(Ia−Id)+(Ic−Ib) (S3). If focus control signal FE is not equal to zero (S4—No), objective lens 104 moves according to the focus control signal FE (S2). If focus control signal FE is equal to zero (S4—Yes), the focus control system ends the focus control (S5). That is, the focus control system runs the focus control so that focus control signal FE becomes equal to zero.

Thus, light-blocking element 108 is disposed in front of cylindrical lens 106 and blocks an area extending from boundary BD, which divides one pair of light receiving areas 107a, 107d and the other pair of light receiving areas 107b, 107c, along X-direction XD, to length Ly1/2. Accordingly, even if light receiving areas 107a, 107b, 107c, 107d are misaligned along Y-direction YD, since light receiving areas 107a, 107b, 107c, 107d receives the reflected light at area except a misaligned part (that is, an area adjacent to boundary BD), it is possible to curb influence of the misalignment in Y-direction YD of four-quadrant detector 107. Accordingly, since optical disk apparatus 1 performs focus control with errors in focus control signal FE reduced, it is possible to curb influence of the misalignment on the focus control and to improve accuracy in reading data from the optical disk 105.

Furthermore, light-blocking element 108 is disposed on first light path LP1 different from second light path LP2 and is disposed between beam splitter 102 and four-quadrant detector 107. Accordingly, light-blocking element 108 does not disturb light travelling from laser diode 101 to optical disk 105. Also, even if the tracking control is performed, it is possible to curb influence of the misalignment on the focus control and to improve accuracy in reading data from the optical disk 105.

### Second Embodiment

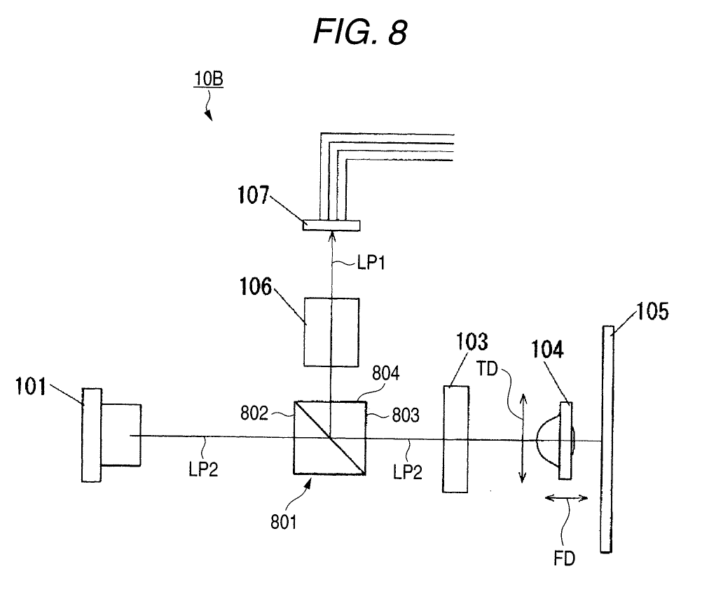

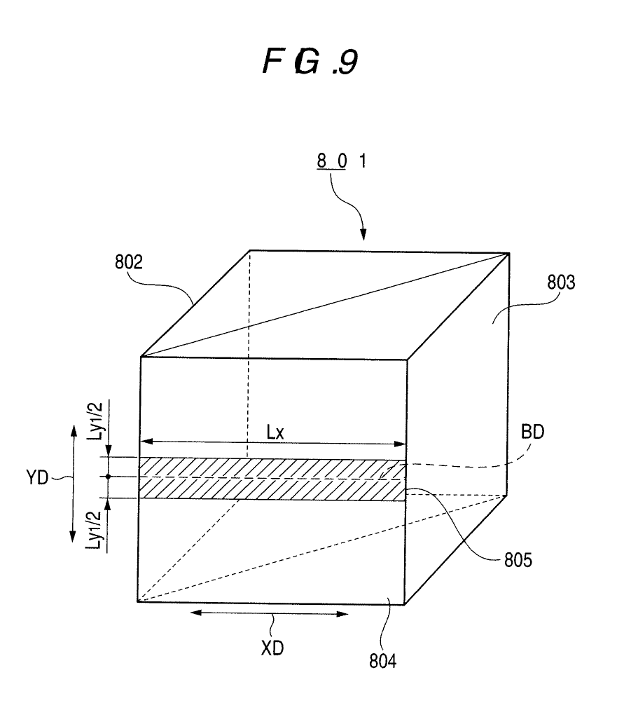

The second embodiment will now be described with reference to FIGS. 8 and 9. FIG. 1 shows the structure of optical disk apparatus 1 of the second embodiment as well as the first embodiment. Also, in the second embodiment, the elements in FIG. 2 are the same as those in FIG. 8 except light-blocking element 108 and beam splitter 801 (hereinafter described).

Referring to FIG. 8, unlike optical system 10A in FIG. 2, optical system 10B has further beam splitter 801 but does not have light-blocking element 108. Laser diode 101 emits the light as a light source toward second light path LP2. The light emitted from laser diode 101 penetrates beam splitter 102 and collimator lens 103 through second light path LP2. Objective lens 104, the numeric aperture of which is 0.73 or thereabouts, focuses the light on optical disk 105. Optical disk 105 has a transparent cover layer on its data surface which is 0.11 mm thick or thereabouts. The light penetrating the cover layer forms a focus spot on the data surface. If optical disk 105 rotates, the data surface periodically waggles in focus direction FD shown in FIG. 8. The light is required to be focused on such data surface during a recording and reproducing process. Optical disk apparatus 1 has a focus control system, which performs focus control using objective lens 104. Specifically, the focus control system moves objective lens 104, according to displacement along focus direction FD of optical disk 105, so as to focus the light.

Objective lens 104 periodically moves in tracking direction TD, according to rotation of optical disk 105.

Objective lens 104 has a surface, which is opposite to optical disk 105, 1 mm in diameter or thereabouts. Since optical system 10A is downsized with this size, optical pick-up 1101 can be downsized enough to mount a small-sized optical disk apparatus as shown in this embodiment. A conventional objective lens 3 mm in diameter is used for a recording medium such as a CD and a DVD 120 mm in diameter. The proportion of lens shift to the diameter of objective lens 104 is about three times wider than the conventional objective lens. Specifically, the proportion increases by 7 to 20% compared with the conventional objective lens.

Beam splitter 801 reflects the light reflected from optical disk 105 toward first light path LP1. The reflected light travels along first light path LP1 different from second light path LP2, and reaches cylindrical lens 106. Cylindrical lens 106 adds the astigmatic characteristic to the light. Four-quadrant detector 107 has the function of a light receiving element, and receives the light. Four-quadrant detector 107 has four light receiving areas into which is divided by a line parallel to X-direction XD and a line parallel to Y-direction YD as discussed previously. The light axis is aligned with the center of four-quadrant detector 107.

If cylindrical lens 106 adds the astigmatic characteristic to the light, the shape of the light on four-quadrant detector 107 varies according to distance from objective lens 104 to optical disk 105 in focus direction FD. Each light receiving area of four-quadrant detector 107 converts the shape of the light into an electric signal, and the detector outputs the electric signal.

Referring to FIG. 9, beam splitter 801 has first surface 802, second surface 803 and third surface 804. Light emitted from laser diode 101 enters first surface 802 from second light path LP2, and exits from second surface 803. Light reflected by optical disk 105 enters again second surface 803, and exits from third surface 804 toward first light path LP1.

Beam splitter 801 has light-blocking film 805 (hatching portion) on third surface 804, as well as light-blocking film 202 on light-blocking element 108 for blocking a part of the reflected light. Light-blocking film 805 is rectangular in shape, and has length Lx along X-direction XD and length Ly1 along Y-direction YD. Length Ly1 extends from boundary BD to Ly1/2h. Boundary BD divides, along X-direction XD, four light receiving areas, and blocks a part of light by light-blocking film 805. That is, boundary BD is parallel to X-direction XD, and optically corresponds to tracking direction TD. Also, the shape of light-blocking film 805 is not limited to rectangular. As long as an area of light-blocking film 805 is shaped along boundary BD, any shape may be applied to achieve the effects of this invention.

Thus, light-blocking film 805 is disposed in front of cylindrical lens 106 and blocks an area extending from boundary BD, which divides one pair of light receiving areas 107a, 107d and the other pair of light receiving areas 107b, 107c, along X-direction X), to length Ly1/2. Accordingly, even if light receiving areas 107a, 107b, 107c, 107d are misaligned along Y-direction YD, since light receiving areas 107a, 107b, 107c, 107d receive the reflected light at an area except a misaligned part (that is, an area adjacent to boundary BD), it is possible to curb influence of the misalignment in Y-direction YD of four-quadrant detector 107. Accordingly, since optical disk apparatus 1 performs focus control with errors in focus control signal FE reduced, it is possible to curb influence of the misalignment on the focus control and to improve accuracy in reading data from the optical disk 105.

Moreover, light-blocking film 805 is disposed on first light path LP1 different from second light path LP2 and is disposed between beam splitter 102 and four-quadrant detector 107. Accordingly, light-blocking film 805 does not disturb light travelling from laser diode 101 to optical disk 105. Also, even if the tracking control is performed, it is possible to curb influence of the misalignment on the focus control and to improve accuracy in reading data from the optical disk 105.

Furthermore, since light-blocking film 805 is provided in beam splitter 801, it is unnecessary to provide individual parts such as light-blocking element 108. It is possible to curb influence of the misalignment on the focus control without reducing characteristics of recording data on optical disk 105 and reproducing data from optical disk 105. Moreover, it is possible to downsize optical disk apparatus 1.

### Third Embodiment

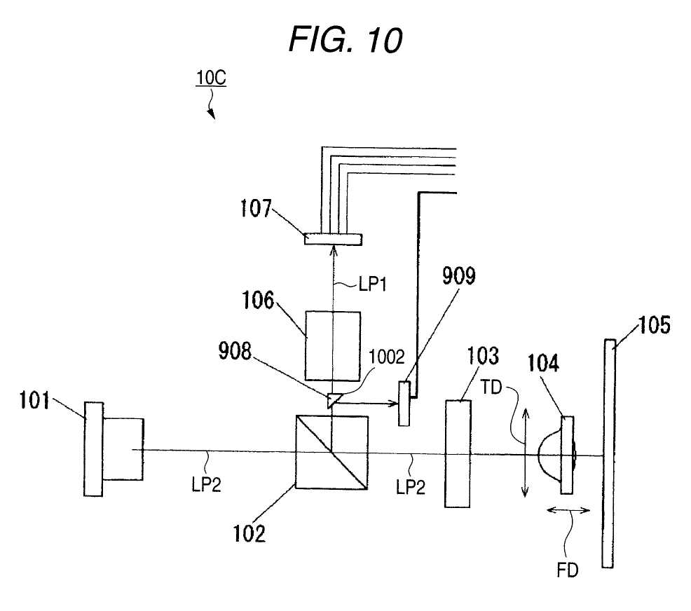

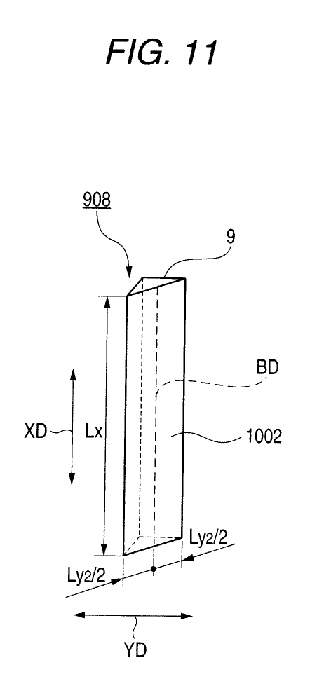

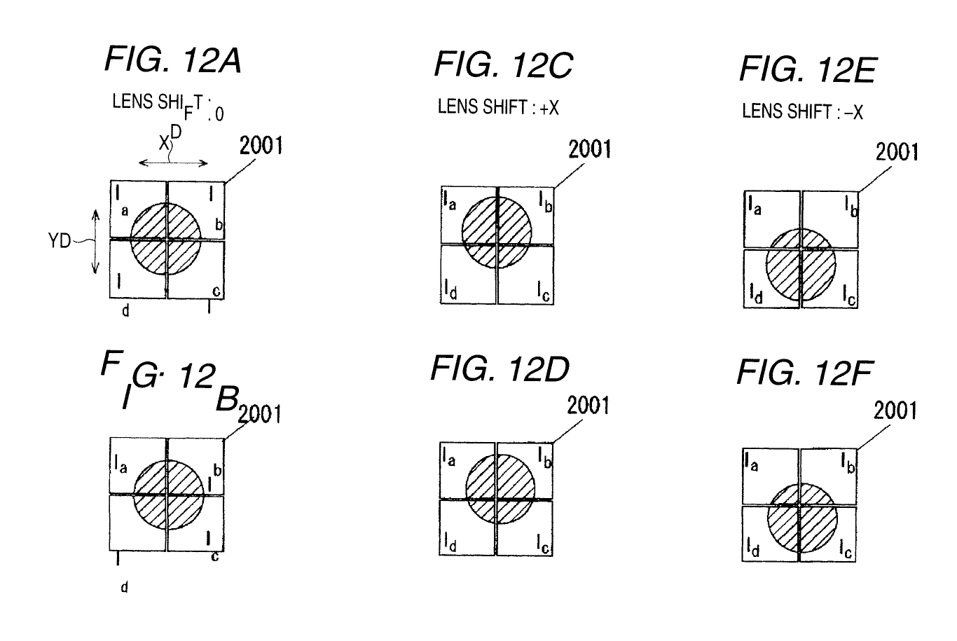

The third embodiment will now be described with reference to FIGS. 10 and 11. FIG. 1 shows the structure of optical disk apparatus 1 of the third embodiment as well as the first and second embodiments. Also, in the third embodiment, elements in FIG. 2 are the same as those in FIG. 10 except light-blocking element 108 and reflection mirror 908 (hereinafter described) and optical detector 909 (hereinafter described).

Referring to FIG. 10, unlike optical system 10A in FIG. 2, optical system 10C has further reflection mirror 908 and optical detector 909 but does not have light-blocking element 108. Laser diode 101 emits the light as a light source toward second light path LP2. The light emitted from laser diode 101 penetrates beam splitter 102 and collimator lens 103 through second light path LP2. Objective lens 104 has a numeric aperture of 0.73 or thereabouts, and focuses the light on optical disk 105. Optical disk 105 has a transparent cover layer on its data surface; this cover layer is 0.11 mm-thick or thereabouts. The light penetrating the cover layer forms a focus spot on the data surface. If optical disk 105 rotates, the data surface periodically waggles in focus direction FD. The light is required to be focused on such a data surface during a recording and reproducing process. Optical disk apparatus 1 has a focus control system, which performs focus control using objective lens 104. Specifically, the focus control system moves objective lens 104, according to displacement along focus direction FD of optical disk 105, so as to focus the light.

Objective lens 104 periodically moves in tracking direction TD according to rotation of optical disk 105.

Objective lens 104 has a surface, which is opposite to optical disk 105, 1 mm in diameter or thereabouts. Since optical system 10A is downsized with this size, optical pick-up 1101 can be downsized enough to mount a small-sized optical disk apparatus as shown in this embodiment. A conventional objective lens 3 mm in diameter is used for a recording medium such as CD and DVD 120 mm in diameter. The proportion of lens shift to the diameter of objective lens 104 is about three times wider than the conventional objective lens. Specifically, the proportion increases by 7 to 20% compared with the conventional objective lens.

Beam splitter 102 reflects light reflected by optical disk 105 toward first light path LP1. The light reflected by beam splitter 102 enters from second light path LP2, and reaches reflection mirror 908.

Reflection mirror 908 reflects a part of the light reflected by optical disk 105 to optical detector 909. Optical detector 909 detects the light from reflection mirror 908, and generates a reproducing signal. The generated reproducing signal increases the intensity of reproducing signal. Accordingly, it is possible to improve characteristics of the reproducing process.

Referring to FIG. 11, reflection mirror 908 has reflection surface 1002. Reflection surface 1002 is rectangular in shape, and has length Lx along X-direction X) and length Ly2 along Y-direction. Length Ly2 extends from boundary BD to Ly2/2h. Boundary BD divides, along X-direction XD, four light receiving areas, and polarizes a part of the light by reflection surface 1002. That is, boundary BD is parallel to X-direction XD, and optically corresponds to tracking direction TD. Also, the shape of reflection surface 1002 is not limited to rectangular. As long as an area of reflection surface 1002 is shaped along boundary BD, any shape may be applied to achieve the effects of this invention.

Thus, reflection mirror 908 is disposed in front of cylindrical lens 106 and blocks an area extending from boundary BD, which divides light receiving areas 107a, 107b, 107c, 107d along X-direction XM, to length Ly2/2. Accordingly, even if light receiving areas 107a, 107b, 107c, 107d are misaligned along Y-direction YD, since light receiving areas 107a, 107b, 107c, 107d receives the reflected light at area except a misaligned part (that is, an area adjacent to boundary BD), it is possible to curb influence of the misalignment in Y-direction YD of four-quadrant detector 107. Accordingly, since optical disk apparatus 1 performs focus control with errors in focus control signal FE reduced, it is possible to curb influence of the misalignment on the focus control and to improve accuracy in reading data from the optical disk 105.

Moreover, reflection mirror 908 is disposed on second light path LP2 different from first light path LP1 and is disposed between beam splitter 102 and four-quadrant detector 107. Accordingly, reflection mirror 908 does not disturb light travelling from laser diode 101 to optical disk 105. Also, even if the tracking control is performed, it is possible to curb influence of the misalignment on the focus control and to improve accuracy in reading data from the optical disk 105.

The foregoing description illustrates and describes the present invention. However, the disclosure shows and describes only the preferred embodiments of the invention, but it is to be understood that the invention is capable of use in various other combinations, modifications, and environments. Also, the invention is capable of change or modification, within the scope of the inventive concept, as expressed herein, that is commensurate with the above teachings and the skill or knowledge of one skilled in the relevant art. For example, one or more elements of each embodiment may be omitted or incorporated into the other embodiments.

The foregoing description of implementations and embodiments of the invention have been presented for purposes of non-limiting illustration and description. Although the present invention has been described herein with reference to particular structures, materials and embodiments, the present invention is not intended to be limited to the particular features and details disclosed herein. Rather, the present invention extends to all functionally equivalent structures, methods and uses, such as are within the scope of the appended claims. The descriptions provided herein are not exhaustive and do not limit the invention to the precise forms disclosed. The foregoing embodiment examples have been provided merely for purposes of explanation and are in no way to be construed as limiting the scope of the present invention. The words that have been used herein are words of description and illustration, rather than words of limitation. The present teachings can readily be realized and applied to other types of apparatuses. Further, modifications and variations, within the purview, scope and sprit of the appended claims and their equivalents, as presently stated and as amended hereafter, are possible. in light of the above teachings or may be acquired from practicing the invention. Furthermore, although elements of the invention may be described or claimed in the singular, the plural is contemplated unless limitation to the singular is explicitly stated Alternative structures discussed for the purpose of highlighting the invention's advantages do not constitute prior art unless expressly so identified. No one or more features of the present invention are necessary or critical unless otherwise specified.

This application is based on the Japanese Patent Application No. 2007-101536 filed on Apr. 9, 2007, the entire contents of which are expressly incorporated by reference herein.

What is claimed is:

1. An optical disk apparatus for performing focus control and tracking control, the focus control focusing an objective lens on an optical disk, and the tracking control making the objective lens track a partial area on the optical disk, the optical disk apparatus comprising:
a light-blocking element that is disposed on a first light path on which light reflected by the optical disk travels and that blocks a part of the reflected light; and
a light detector that detects, for the focus control, the reflected light which passes said light-blocking element,
wherein said light-blocking element has a predetermined area for blocking the reflected light, the predetermined area extending along a direction optically corresponding to the tracking direction in which the objective lens tracks, for the tracking control, the partial area on the optical disk.

2. The optical disk apparatus according to claim 1, further comprising:
a lens that is disposed between said light-blocking element and said light detector, and that adds an astigmatic characteristic to the reflected light which passes said light-blocking element.

3. The optical disk apparatus according to claim 1, wherein said light detector includes four light receiving areas, and the four light receiving areas are divided, along the direction optically corresponding to the tracking direction, into two pairs of light receiving areas.

4. The optical disk apparatus according to claim 1, further comprising:
a light source that emits the light that passes to the optical disk through the objective lens, and that is disposed on a second light path different from the first light path; and
a beam splitter that is disposed on both the first light path and second light path, and that reflects the light reflected by the optical disk toward the first light path.

5. The optical disk apparatus according to claim 4, wherein said light-blocking element is disposed between said beam splitter and said light detector.

6. The optical disk apparatus according to claim 4, wherein said light-blocking element is disposed in said beam splitter.

7. The optical disk apparatus according to claim 1, wherein said light-blocking element is a film having the predetermined area.

8. The optical disk apparatus according to claim 1, wherein said light-blocking element blocks a part of the reflected light by polarizing the reflected light.

9. The optical disk apparatus according to claim 8, wherein said light detector comprises a polarized light detector that detects the reflected light polarized by said light-blocking element.

10. A focus control method for performing focus control, the focus control focusing light passing through an objective lens onto an optical disk, and the objective lens tracking a partial area on the optical disk by tracking control, the focus control method comprising:
(a) blocking a part of light reflected by the optical disk;
(b) detecting the reflected light not blocked in step (a); and
(c) performing the focus control in accordance with the detection of the reflected light in step (b),
wherein the reflected light is blocked with a predetermined area, the predetermined area extending along a direction optically corresponding to the tracking direction in which the objective lens tracks, for the tracking control, the partial area on the optical disk.
